(19) United States
(12) Patent Application Publication
(10) Pub. No.: US 2009/0144812 A1
(43) Pub. Date: Jun. 4, 2009

(54) ENTRY AUXILIARY APPARATUS, ENTRY AUXILIARY SYSTEM, ENTRY AUXILIARY METHOD AND ENTRY AUXILIARY PROGRAM

(76) Inventors: Naoki Sasamura, Tokyo (JP); Masahiro Suzuki, Tokyo (JP); Kouki Miyamoto, Tokyo (JP); Yuuji Aoyagi, Tokyo (JP); Takuya Nishio, Tokyo (JP); Go Mase, Tokyo (JP); Takayuki Sugimori, Tokyo (JP)

Correspondence Address: NEC CORPORATION OF AMERICA, 6535 N. STATE HWY 161, IRVING, TX, 75039, US

(21) Appl. No.: 12/275,641

(22) Filed: Nov. 21, 2008

(30) Foreign Application Priority Data
Nov. 29, 2007 (JP) 2007-308522

(51) Int. Cl. H04L 9/32

(52) U.S. Cl. 726/5

(57) ABSTRACT

An entry auxiliary apparatus includes: an authentication entry detection unit, an adequacy determination unit and an entry auxiliary unit. The authentication entry detection unit detects a first authentication server URL included in data of a web page displayed. The adequacy determination unit compares the first authentication server URL with a second authentication server URL included in login information indicating an input history of authentication information and a third authentication server URL included in a service group. The service group, which includes a group of authentication server URLs locating authentication servers that authenticate with an identical authentication information, is related to the login information. The adequacy determination unit relates the login information to an adequacy level depending on a result of the comparison. The entry auxiliary unit assists input of authentication information into the web page based on the login information and the adequacy level.

### INCORPORATION BY REFERENCE

This application is based upon and claims the benefit of priority from Japanese patent application No. 2007-308522, filed on Nov. 29, 2007, the disclosure of which is incorporated herein in its entirely by reference.

### TECHNICAL FIELD

The present invention relates to an entry auxiliary technique. In particular, the present invention relates to an entry auxiliary technique that assists input of authentication information of a user to an entry screen.

### BACKGROUND ART

In a service through a network, a service provider authenticates a user by using authentication information in order to determine whether or not to provide the service for the user. The authentication information includes a user ID and a password. The service provider prepares a web page for the user to input the authentication information. The web page is displayed on a terminal that the user uses. Information that locates the web page is referred to as a “WPU: Web Page URL (Uniform Resource Locator)”. A server that authenticates the user is referred to as an “authentication server”. Information that locates the authentication server is referred to as an “ASU: Authentication Server URL”.

When providing the user with the service, the service provider has the user input the authentication information into the web page. The authentication server URL is directly or indirectly embedded in the web page, and the authentication information input by the user is transmitted to the authentication server in accordance with the authentication server URL. The authentication server performs the authentication processing based on the input authentication information.

Even in a case of a plurality of web pages with different web page URLs, it is likely that a user can be authenticated by the same authentication information if the corresponding authentication server URLs are the same or mutually related.

Usually, different authentication information are required for different services. However, the same service provider may provide a plurality of services, or a service provider may cooperate with another service provider. In these cases, a user may enjoy different services with using the same authentication information.

Conventionally, a user relates authentication information to a web page URL or a service name, and the user memorizes or electrically stores the authentication information. Alternatively, the user writes down or prints out the authentication information on a paper and stores the paper. When a web page for the user to input authentication information is displayed on a browser or the like, the user refers to the web page URL, the service name or appearance of the web page to retrieve the corresponding authentication information from lots of authentication information stored. Then, the user inputs the retrieved authentication information into the web page.

For example, a user relates authentication information to a web page URL and stores a record indicating the relationship in a database. When the user inputs different authentication information into the same web page, the user stores a new record indicating a relationship between the web page URL and the input authentication information in the database. When a web page is displayed on a browser thereafter, entry auxiliary software obtains its web page URL from the browser and retrieves authentication information related to the web page URL from the database. If there is authentication information related to the web page URL, the entry auxiliary software inputs the retrieved authentication information into the web page. If a plurality authentication information are found as a result of the retrieval, the entry auxiliary software displays a list of the authentication information and has the user select appropriate one authentication information.

Japanese Laid-Open Patent Application JP-2002-63138 discloses an Internet connection apparatus. According to the technique, names of information distribution services are stored beforehand, and a desired service is selected from the information distribution services. The internet connection apparatus identifies a URL corresponding to the selected service and sends a request to a service providing system having the URL. In response to an authentication request from the service providing system, the internet connection apparatus obtains a user ID and a password by converting a service ID that is given to the selected service. Then, the internet connection apparatus transmits the obtained user ID and password to the service providing system.

### SUMMARY

In order to improve user convenience, a service provider may provide different services or may cooperate with another service provider to provide different services. In these cases, a user may enjoy the different services with using the same authentication information. The user just needs to input the same authentication information, even when web page URLs of respective web pages into which authentication information is input are different from each other.

According to the above-described related technique, each record stored in the database indicates a relationship between authentication information and a web page URL. In this case, however, entry auxiliary processing is not executed if there is no record indicating a desired web page URL in the database, and thus a new record indicating a relationship between the desired web page URL and corresponding authentication information needs to be stored in the database. Even when the same one authentication information can be used for a plurality of services, the database needs to store a plurality of records respectively indicating relationships between the same one authentication information and a plurality of web page URLs of the plurality of services. This clearly causes burden for the user and the database. Moreover, the record in the database needs to be edited or deleted with respect to each web page URL, which can cause erroneous edit or deletion.

In a case where one web page URL is related to a plurality of authentication information, the entry auxiliary software needs to have the user select one authentication information from the plurality of authentication information that is to be input to the web page. If the number of authentication information related to the one web page URL becomes larger, it leads to complexity.

According to the related technique, as described above, the authentication information is related to the web page URL, and the record indicating the relationship is stored in the database, which causes several problems.

According to the present invention, authentication information is related to an authentication server URL. Even when the authentication server URL is slightly different, the same authentication information is used for authentication processing. Also, information of cooperation between services is utilized, and one authentication information is used for a plurality of authentication server URLs, which improves user convenience.

In a first aspect of the present invention, an entry auxiliary apparatus is provided. The entry auxiliary apparatus includes an authentication entry detection unit, an adequacy determination unit and an entry auxiliary unit. A first authentication server URL that locates an authentication server that authenticate users is included in data of a web page displayed. A second authentication server URL is included in login information that indicates an input history of authentication information of a user. A service group includes a group of authentication server URLs locating authentication servers that authenticate with an identical authentication information. The login information is related to the service group. A third authentication server URL is included in the service group. The authentication entry detection unit detects the first authentication server URL. The adequacy determination unit compares the first authentication server URL with the second authentication server URL included in the login information and the third authentication server URL included in the service group. The entry auxiliary unit assists input of authentication information into the web page based on the login information and the adequacy level.

In a second aspect of the present invention, an entry auxiliary system is provided. The entry auxiliary system includes a user terminal, a login history information list server and a service group information list server. The login history information list server manages a login history information list that includes login information indicating an input history of authentication information of a user. The service group information list server manages a service group information list that includes a service group. The service group includes a group of authentication server URLs locating authentication servers that authenticate with an identical authentication information. The user terminal obtains the login history information list and the service group information list. The user terminal relates the login information to the service group. The user terminal detects a first authentication server URL included in data of a web page displayed, wherein the first authentication server URL locates an authentication server that authenticate users. The user terminal compares the first authentication server URL with a second authentication server URL included in the login information and a third authentication server URL included in the service group. The user terminal relates the login information to an adequacy level depending on a result of the comparison. The user terminal assists input of authentication information into the web page based on the login information and the adequacy level.

In a third aspect of the present invention, an entry auxiliary method is provided. The entry auxiliary method includes: (a) detecting a first authentication server URL included in data of a web page displayed, wherein the first authentication server URL locates an authentication server that authenticate users; (b) comparing the first authentication server URL with a second authentication server URL included in login information indicating an input history of authentication information of a user and a third authentication server URL, wherein a service group includes a group of authentication server URLs locating authentication servers that authenticate with an identical authentication information, the login information is related to the service group, and the third authentication server URL is included in the service group; (c) relating the login information to an adequacy level depending on a result of the comparing; and (d) assisting input of authentication information into the web page based on the login information and the adequacy level.

In a fourth aspect of the present invention, an entry auxiliary program recorded on a computer-readable medium is provided. When executed, the entry auxiliary program causes a computer to perform the above-mentioned entry auxiliary method.

Entry operation history information based on cooperation information between services is captured. It is thus possible to extend authentication servers without burdening a user with registration of authentication information. It should be noted that the entry operation history information is history information of past authentication processing with respect to the user. Data-structured entry operation history information is the login information. The login information indicates input history of the authentication information input by the user. Also, adequacy between the authentication information and the authentication server is determined based on the matching degree of the captured entry operation history information and the authentication server URL. The entry auxiliary processing can be performed by using the authentication information that matches to a condition at the time of entry. The degree of adequacy is expressed numerically and quantitative judgment is performed. Thus, a clear rule for the entry auxiliary processing is provided. It should be noted that the adequacy means to what degree the authentication is successfully done when certain authentication information is sent to a certain authentication server. The degree is the adequacy level. For example, the adequacy level is classified into 1 to 4, and the “adequacy level 1” indicates that the authentication is most likely to be done successfully.

### BRIEF DESCRIPTION OF THE DRAWINGS

The above and other objects, advantages and features of the present invention will be more apparent from the following description of certain exemplary embodiments taken in conjunction with the accompanying drawings, in which:

FIG. 1 is a schematic diagram showing a configuration example of an ID aggregation service system according to an exemplary embodiment of the present invention;

FIG. 2 shows an example of a service group information list according to the exemplary embodiment;

FIG. 3 shows an example of a login history information list according to the exemplary embodiment;

FIG. 4 is a flow chart showing overall processing in the exemplary embodiment;

FIG. 5 is a block diagram showing a configuration example of a user terminal according to the exemplary embodiment;

FIG. 6 is a flow chart showing preliminary processing according to the exemplary embodiment;

FIG. 7 is a flow chart showing processing by the ID aggregation service system according to the exemplary embodiment;

FIG. 8 shows examples of the service group information list and the login history information list according to the exemplary embodiment;

FIG. 9 shows an example of login information related to service groups according to the exemplary embodiment;

FIG. 10 shows a first example of login information related to adequacy levels;

FIG. 11 shows a second example of login information related to adequacy levels;

FIG. 12 shows a third example of login information related to adequacy levels; and

FIG. 13 shows a fourth example of login information related to adequacy levels.

### EXEMPLARY EMBODIMENTS

Exemplary embodiments of the present invention will be described below with reference to the attached drawings.

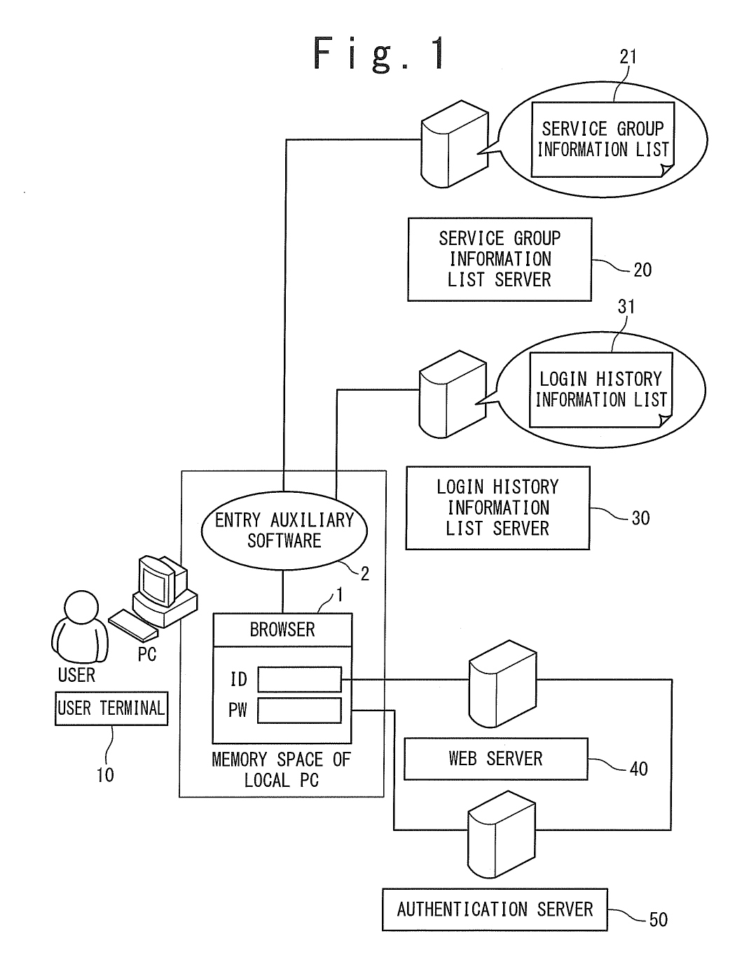

FIG. 1 schematically shows a configuration example of an ID aggregation service system (entry auxiliary system) according to an exemplary embodiment. The ID aggregation service system according to the exemplary embodiment includes a user terminal 10, a service group information list server 20, a login history information list server 30, a WEB server 40 and an authentication server 50.

The user terminal 10 is a communication device used by a user for browsing a web page, inputting a user ID and a password, and the like. Examples of the user terminal 10 include a personal computer, a cell phone, a digital home appliance, a gadget and the like that enable a user to browse a web page. In the exemplary embodiment, the user terminal 10 is a network supporting computer. The user terminal 10 as the network supporting computer is provided with a processor (processing device) such as a CPU, a memory device (memory unit), a communication interface (communication device), a display device (display unit) and an input device (input unit). The input device is exemplified by a key board, a tablet, a numeric keypad on a screen, a reader for biologic information or an IC card, and so forth. The user terminal 10 may be further provided with other internal devices and peripheral devices.

Moreover, the user terminal 10 (entry auxiliary apparatus) is provided with a browser 1 and entry auxiliary software 2. The user terminal 10 displays the browser 1 on the display device by using the processor. The user terminal 10 executes the entry auxiliary software 2 by using the processor to process data input through the input device and the communication interface and store data in the memory device. The entry auxiliary software 2 may operate outside the user terminal 10. In a case where the user terminal 10 is a thin client, for example, the entry auxiliary software 2 operates on a server that manages application software and files.

The browser 1 displays a web page, obtains information input by a user, displays the input information on the web page, and changes display contents on the web page in response to the input information. The web page is a login screen or an information entry screen. The browser 1 is a web browser, for example. However, the browser 1 is not limited to a web browser and can be application software that provides a user with a service through a network such as an online game.

The entry auxiliary software 2 assists an entry operation by a user. The entry auxiliary software 2 is a computer program executed by the processor and may be recorded on a computer-readable recording medium. The entry auxiliary processing can be achieved by cooperation of the processor and the entry auxiliary software 2.

The service group information list server 20 manages and provides a service group information list 21. In the exemplary embodiment, the service group information list server 20 is a network supporting computer. The service group information list server 20 as the network supporting computer is provided with a processor (processing device) such as a CPU, a memory device (memory unit), and a communication interface (communication device). The service group information list 21 is stored in the memory device. By using the processor, the service group information list server 20 generates, updates, reads and stores the service group information list 21. Also, the service group information list server 20 communicates with the user terminal 10 through the communication interface. In response to a request from the user terminal 10, the service group information list server 20 supplies the service group information list 21 to the user terminal 10. If the service group information list 21 is generated by direct input by a user, the service group information list server 20 may further comprise an input device.

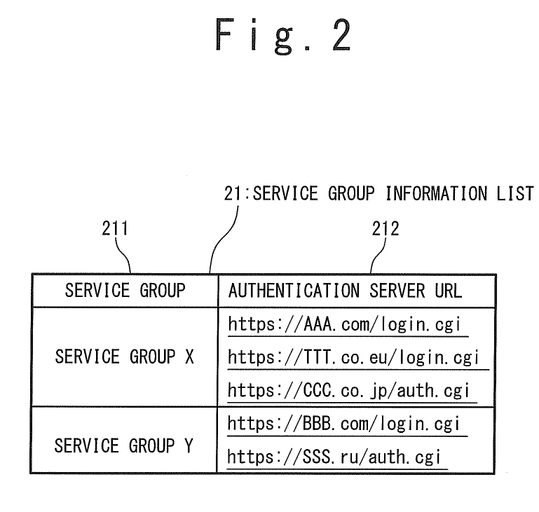

FIG. 2 shows an example of the service group information list 21. The service group information list 21 includes a service group 211 and an authentication server URL 212.

The service group 211 is identification information that indicates service groups. The authentication server URL 212 indicates authentication server URLs that belong to respective service groups. Here, authentication server URLs locating authentication servers that authenticate with an identical authentication information are grouped, and the group of authentication server URLs constitute a service group. That is to say, authentication server URLs associated with web pages into which the same authentication information is input for authentication are grouped, and a service group includes the group of authentication server URLs. The service group information list 21 indicates a relationship between the service group and the group of authentication server URLs, and is stored in the memory device of the service group information list server 20.

The login history information list server 30 manages and provides a login history information list 31. In the exemplary embodiment, the login history information list server 30 is a network supporting computer. The login history information list server 30 as the network supporting computer is provided with a processor (processing device) such as a CPU, a memory device (memory unit), and a communication interface (communication device). The login history information list 31 is stored in the memory device. By using the processor, the login history information list server 30 generates, updates, reads and stores the login history information list 31. Also, the login history information list server 30 communicates with the user terminal 10 through the communication interface. In response to a request from the user terminal 10, the login history information list server 30 supplies the login history information list 31 to the user terminal 10. If the login history information list 31 is generated by direct input by a user, the login history information list server 30 may further comprise an input device.

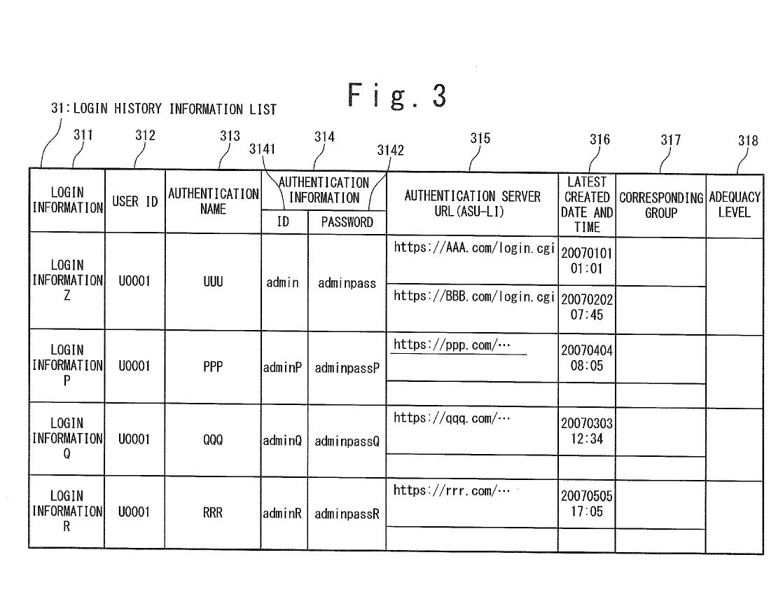

FIG. 3 shows an example of the login history information list 31. The login history information list 31 includes login information 311, an user ID 312, an authentication name 313, authentication information 314, an authentication server URL 315, a latest created date and time 316, a corresponding group 317 and an adequacy level 318.

The login information 311 is identification information that indicates a record of login information registered on the login history information list 31. The registered login information indicates an input history of authentication information input by a user. The user ID 312 is identification information that specifies a user or the user terminal 10. For example, the user ID 312 is a user ID of a service, a telephone number, a mail address, an IP address, a unique number of the entry auxiliary software 2, or a unique number of a hardware installed in the user terminal 10. The authentication name 313 is identification information that a user can arbitrarily register depending on usage of the authentication information 314. The authentication information 314 includes an ID 3141 and a password 3142. The ID 3141 indicates an ID input by a user. The password 3142 indicates a password input by a user. The authentication server URL 315 (ASU-LI) indicates a URL that locates an authentication server to which the authentication information 314 is supplied. The latest created date and time 316 indicates a date and time when the authentication information 314 is last registered. The corresponding group 317 indicates the above-mentioned service group in which the authentication server URL 315 is included. The adequacy level 318 indicates a degree (probability) of whether or not the authentication is successfully done when the authentication information 314 is sent to the authentication server URL 315.

The service group information list server 20 does not necessarily have the service group information list 21 as it is. The service group information list server 20 may directly or indirectly have information included in the service group information list 21, collect the information, and provide them as the service group information list 21. Similarly, the login history information list server 30 does not necessarily have the login history information list 31 as it is. The login history information list server 30 may directly or indirectly have information included in the login history information list 31, collect the information, and provide them as the login history information list 31. The service group information list server 20 and the login history information list server 30 can be the same server.

The WEB server 40 provides a web page that requires authentication of a user for the user terminal 10. When authentication information such as an ID and a password is input from the user terminal 10, the WEB server 40 transmits the authentication information to the authentication server 50. Then, the WEB server 40 receives a result of authentication based on the authentication information from the authentication server 50. If the authentication information is successfully authenticated, the WEB server 40 permits access and provides a service for the user. For example, the service provides contents for shopping in a members-only site, browsing a bulletin board or a weblog, downloading video data or music data, or the like. In the exemplary embodiment, the WEB server 40 is a network supporting computer. The WEB server 40 as the network supporting computer is provided with a processor (processing device) such as a CPU, a memory device (memory unit), and a communication interface (communication device). By using the processor, the WEB server 40 performs the above-mentioned processing and stores data of the processing and the web page in the memory device. Also, the WEB server 40 communicates with the user terminal 10 and the authentication server 50 through the communication interface.

The authentication server 50 receives a request from the WEB server 40. In response to the request, the authentication server 50 performs user authentication based on the authentication information such as a user ID and a password that is received from the user terminal 10 or the WEB server 40. Then, the authentication server 50 transmits a result of the authentication to the WEB server 40. At this time, the authentication server 50 may store the authentication information such as the user ID and the password that is received from the user terminal 10 or the WEB server 40. In the exemplary embodiment, the authentication server 50 is a network supporting computer. The authentication server 50 as the network supporting computer is provided with a processor (processing device) such as a CPU, a memory device (memory unit), and a communication interface (communication device). By using the processor, the authentication server 50 performs the above-mentioned processing and stores data of the processing in the memory device. Also, the authentication server 50 communicates with the user terminal 10 and the WEB server 40 through the communication interface. The WEB server 40 and the authentication server 50 can be the same server.

Let us consider the following case example. The authentication server 50 creates a pair of authentication permission tickets as the authentication information. One of the pair is an authentication permission ticket TA, and the other is an authentication permission ticket TB. The authentication server 50 stores the authentication permission ticket TA and supplies the authentication permission ticket TB to the user terminal 10. When requesting the service, the user terminal 10 transmits the authentication permission ticket TB to the WEB server 40. When receiving the authentication permission ticket TB from the user terminal 10, the WEB server 40 transmits the received authentication permission ticket TB to the authentication server 50. The authentication server 50 performs matching between the stored authentication permission ticket TA and the received authentication permission ticket TB. When it is confirmed that the received authentication permission ticket TB matches the stored authentication permission ticket TA, the authentication server 50 notifies the WEB server 40 of the confirmation. In response to the confirmation from the authentication server 50, the WEB server 40 provides contents for the user terminal 10.

In the service providing, the authentication information is associated with (related to) the service. The association of the authentication information and the service is performed by the authentication server 50. That is to say, the authentication information is more closely related to the authentication server URL than to the web page URL. Even in a case of different authentication server URLs, the authentication server URLs may have the same domain name or the same host name. When the authentication server URLs are similar to each other to some extent, it is likely that the authentication processing is performed by the same authentication server and the user is authenticated by the same authentication information.

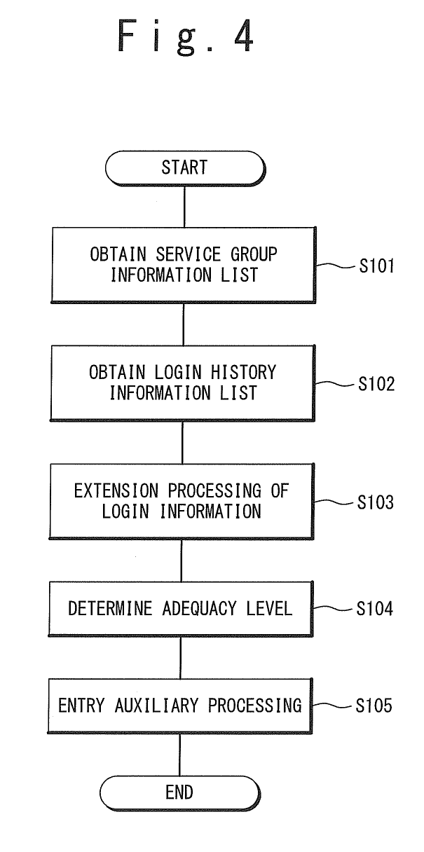

An overall processing in the exemplary embodiment will be described below with reference to a flow chart shown in FIG. 4.

(1) Step S101:

The user terminal 10 obtains the service group information list 21 from the service group information list server 20. Then, the user terminal 10 obtains information on cooperation between services from the service group information list 21.

(2) Step S102:

The user terminal 10 obtains the login history information list 31 from the login history information list server 30. Then, the user terminal 10 obtains the login information (entry operation history information) of a user from the login history information list 31. The login information indicates the input history of the authentication information of the user.

(3) Step S103:

The user terminal 10 refers to the login history information list 31 and the service group information list 21 to perform an extension processing of the login information. In the extension processing of the login information, an authentication server URL included in both of the login history information list 31 and the service group information list 21 is retrieved. If there is such an authentication server URL, it is an identical authentication server URL. Then, the login information and the cooperation information between services are related to each other by using the identical authentication server URL is used as a key. It is thus becomes possible to use the same login information for a plurality of services. The extension processing will be described later in more detail.

(4) Step S104:

The user terminal 10 determines an adequacy level between the login information and an authentication server URL included in a web page. Here, the adequacy means to what degree the authentication is successfully done when certain authentication information included in the login information is sent to the authentication server. The degree is the adequacy level. The adequacy level is determined based on the matching degree of the login information and the authentication server URL.

(5) Step S105:

Based on the above-mentioned adequacy level, the user terminal 10 performs the entry auxiliary processing with regard to entry of the authentication information. That is, the user terminal 10 assists input of the authentication information to the web page, with reference to the login information and the above-mentioned adequacy level. For example, the adequacy level is classified into 1 to 4, and the “adequacy level 1” indicates that the authentication is most likely to be done successfully. In a case of the “adequacy level 1”, for example, the user terminal 10 automatically input optimum authentication information into the web page. In a case of the “adequacy level 2” or “adequacy level 3”, the user terminal 10 displays a list of candidates of the authentication information to have the user select a desired one. In a case of the “adequacy level 4”, the user terminal 10 does not perform the automatic input and display of the authentication information.

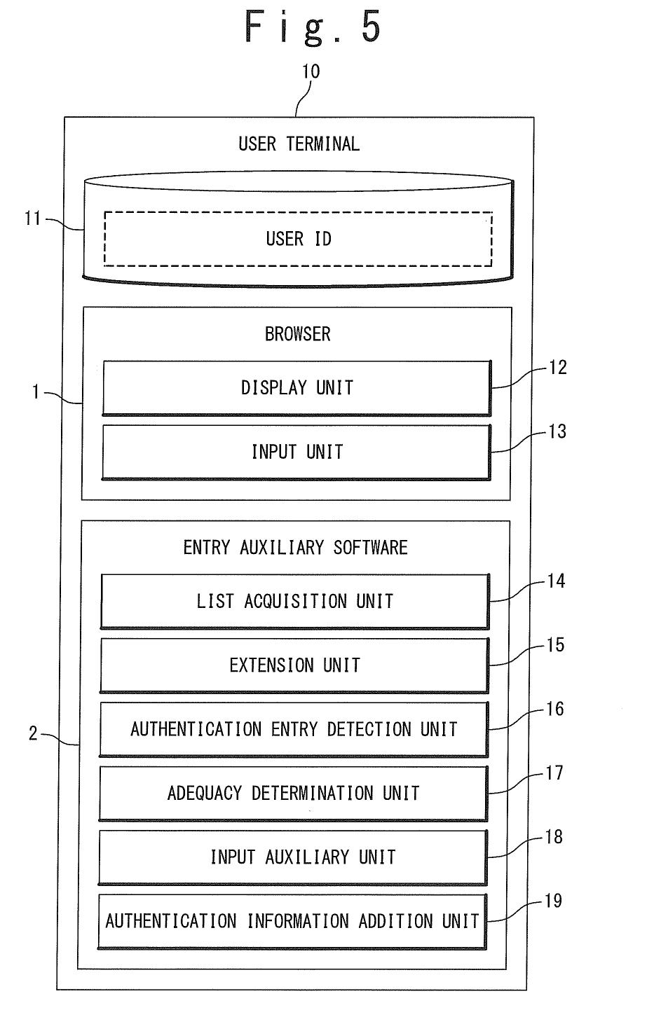

Next, the user terminal 10 (entry auxiliary apparatus) according to the exemplary embodiment will be described below in more detail. FIG. 5 is a function-based block diagram showing a configuration example of the user terminal 10. The user terminal 10 is provided with a memory unit 11, a display unit 12, an input unit 13, a list acquisition unit 14, an extension unit 15, an authentication entry detection unit 16, an adequacy determination unit 17, an entry auxiliary unit 18, and an authentication information addition unit 19.

The memory unit 11 is the memory device used for storing information. For example, the user ID is stored in the memory unit 11. The user ID is information that specifies the user terminal 10 or the user. Moreover, various application software such as the browser 1, the entry auxiliary software 2 and the like and various data are stored in the memory unit 11.

The display unit 12 displays a web page on a display. The display unit 12 can be achieved by display application software such as the browser 1 and the processor that executes the display application software.

The input unit 13 inputs the authentication information such as the user ID and the password to the displayed web page, in response to user operations. The input unit 13 includes the input device such as a key board, a mouse, a tablet or the like and a circuit that reflects input data from the input device to the browser 1. Alternatively, the input unit 13 can be the communication device for externally receiving the authentication information. It should be noted that the display unit 12 and the input unit 13 may be integrated to a single device such as a touch panel.

The browser 1 utilizes the above-mentioned display unit 12 and input unit 13. The browser 1 includes the display unit 12 and the input unit 13.

Each of the list acquisition unit 14, the extension unit 15, the authentication entry detection unit 16, the adequacy determination unit 17, the entry auxiliary unit 18 and the authentication information addition unit 19 is based on the entry auxiliary software 2. That is to say, the list acquisition unit 14, the extension unit 15, the authentication entry detection unit 16, the adequacy determination unit 17, the entry auxiliary unit 18 and the authentication information addition unit 19 are achieved by cooperation of the entry auxiliary software 2 and the processor that executes the entry auxiliary software 2. Alternatively, each of the list acquisition unit 14, the extension unit 15, the authentication entry detection unit 16, the adequacy determination unit 17, the entry auxiliary unit 18 and the authentication information addition unit 19 may be a single circuit or a single apparatus that achieves the corresponding function.

When the user terminal 10 is booted or the entry auxiliary software 2 is activated, the list acquisition unit 14 transmits a service group information list request including the user ID to the service group information list server 20, and thereby receives the service group information list 21 from the service group information list server 20 and stores it in the memory unit 11. Coincidentally or subsequently, the list acquisition unit 14 transmits a login history information list request including the user ID to the login history information list server 30, and thereby receives the login history information list 31 from the login history information list server 30 and stores it in the memory unit 11. The login history information list 31 is a list of login information (LI) including the authentication server URL, the authentication information, the user ID and the authentication name. The login information (LI) indicates the input history of the authentication information of the user. Note that the login history information list 31 contains personal data. It is therefore preferable that the list acquisition unit 14 receives the login history information list 31 that is encrypted on the side of the login history information list server 30. In this case, the list acquisition unit 14 restores the encrypted login history information list 31. As in the case of the login history information list 31, it is also possible that the service group information list 21 is encrypted on the side of the service group information list server 20 and the encrypted service group information list 21 is restored on the side of the list acquisition unit 14.

The extension unit 15 performs the extension processing with respect to the login information (LI). In the extension processing, the extension unit 15 makes a comparison between the authentication server URL (ASU-LI) included in the login history information list 31 and the authentication server URL (ASU-SG) included in the service group information list 21, in accordance with a predetermined criterion (adequacy level determination rule). In other words, the extension unit 15 checks whether or not the authentication server URL (ASU-LI) included in the login history information list 31 matches the authentication server URL (ASU-SG) included in the service group information list 21 in accordance with the predetermined criterion (adequacy level determination rule). If the authentication server URL (ASU-LI) matches the authentication server URL (ASU-SG), the extension unit 15 determines that the authentication server URL (ASU-LI) is in the same service group as that of the authentication server URL (ASU-SG). Then, the extension unit 15 relates the corresponding service group to the authentication server URL (ASU-LI). Details of the predetermined criterion (adequacy level determination rule) will be described later.

The authentication entry detection unit 16 searches the data of the web page displayed by the display unit 12 for an entry field for the authentication information and an authentication server URL (ASU-WP) that may be directly or indirectly included in the data of the web page. If the authentication entry detection unit 16 detects the entry field for the authentication information and the authentication server URL (ASU-WP) in the data of the displayed web page, the authentication entry detection unit 16 transmits the authentication server URL (ASU-WP) to the adequacy determination unit 17. For example, the authentication entry detection unit 16 determines a “FORM” tag described in a source HTML (HyperText Markup Language) document of the web page as the entry field for the authentication information. The “FORM” tag includes “input” tag with “type attribute: text” and “type attribute: password”. If a plurality of “FORM” tags that meet the condition are found within the data of the web page, the authentication entry detection unit 16 determines that there are a plurality of entry fields whose number is equal to that of the “FORM” tags. Moreover, when the authentication server URL (ASU-WP) is described in the source HTML document of the web page, the authentication entry detection unit 16 detects the authentication server URL (ASU-WP). Here, the authentication entry detection unit 16 uses the “FORM” tag as a mark for detecting the authentication server URL (ASU-WP) in the HTML document, and obtains an URL specified in “Action attribute” of the “FORM” tag as the authentication server URL (ASU-WP). In a case of an authentication dialog such as Basic authentication where the “FORM” tag is not used, a particular part of the dialog such as a title is used as the mark. That is, the authentication entry detection unit 16 obtains information about the entry field for the authentication information and the authentication server URL (ASU-WP) from the particular part of the dialog. Even when the authentication server URL (ASU-WP) is managed in another file related to the source HTML document of the web page, the authentication entry detection unit 16 reads the authentication server URL (ASU-WP) from the file and detects the authentication server URL (ASU-WP).

The adequacy determination unit 17 compares the authentication server URL (ASU-WP) with the authentication server URL (ASU-SG) included in the service group information list 21 and the authentication server URL (ASU-LI) included in the login history information list 31 after the extension processing by the extension unit 15. Here, the adequacy determination unit 17 makes the comparison with respect to each of the login information included in the login history information list 31 in accordance with the predetermined criterion (adequacy level determination rule). The adequacy determination unit 17 determines the above-mentioned adequacy level with respect to each of the login information, depending on the result of the comparison (matching degree). Then, the adequacy determination unit 17 relates the adequacy level to the login information. Moreover, when the service group in the service group information list 21 is related to the login information in the login history information list 31, the adequacy determination unit 17 makes a comparison between the authentication server URL (ASU-WP) and the authentication server URL (ASU-SG) included in the service group information list 21. When the service group in the service group information list 21 is not related to the login information in the login history information list 31, the adequacy determination unit 17 may not make a comparison between the authentication server URL (ASU-WP) and the authentication server URL (ASU-SG) included in the service group information list 21.

The entry auxiliary unit 18 performs the entry auxiliary processing by assisting input of the authentication information to the web page based on adequacy level related to the login information. As to the login information related to the “adequacy level 1”, the entry auxiliary unit 18 automatically inputs the authentication information included in the login information into an entry field for the authentication information on the web page. As to the login information related to the “adequacy level 2” or “adequacy level 3”, the entry auxiliary unit 18 displays the authentication name indicating the authentication information included in the login information as entry candidates on the display unit 12. The user can select one authentication name (authentication information) by using the input unit 13. For example, the authentication name is displayed on a tool bar of the browser 1 or a dialog box. When an authentication name is selected by the input unit 13, the entry auxiliary unit 18 inputs the authentication information indicated by the selected authentication name into the entry field for the authentication information on the web page. As to the login information related to the “adequacy level 4”, the entry auxiliary unit 18 does not input nor display the authentication information included in the login information. The authentication name in the automatically input login information related to the “adequacy level 1” may also be displayed as an entry candidate.

In a case where a plurality of login information are related to the “adequacy level 1”, the plurality of login information are ranked and more priority may be given to the login information whose latest created or used date and time is closer to the current time. In this case, the entry auxiliary unit 18 automatically inputs the authentication information included in the highest-ranking login information and displays the authentication name with regard to the other login information related to the “adequacy level 1” as entry candidates. To automatically input the login information of the “adequacy level 1” is preferable from a viewpoint of reduction of burden on users.

The authentication information addition unit 19 monitors data transmitted from the user terminal 10 to the outside and analyzes the transmitted data, and thereby obtains the authentication server URL (ASU-WP) associated with the displayed web page and the input authentication information such as the user ID and the password. In a case of the authentication dialog such as the Basic authentication, the authentication information addition unit 19 detects hold-down of a dialog button and obtains the authentication server URL (ASU-WP) and the input authentication information such as the user ID and the password directly from the dialog. When the authentication information addition unit 19 obtains the authentication server URL (ASU-WP) associated with the web page and the input authentication information such as the user ID and the password, the authentication information addition unit 19 displays a necessity confirmation button for saving login information in the login history information list server 30 and an entry field used for inputting an authentication name indicating the authentication information on the display unit 12. Here, the authentication information addition unit 19 judges whether or not the displayed screen is the entry screen and whether or not the entry information is being input to the entry field for the authentication information such as the user ID and the password. Depending on a result of the judgment, the authentication information addition unit 19 displays the necessity confirmation button and the entry field for the authentication name. If the displayed screen is not the entry screen or if the entry information is not being input to the entry field for the authentication information such as the user ID and the password, the authentication information addition unit 19 does not display the necessity confirmation button or the entry field for the authentication name. If the authentication information addition unit 19 receives an instruction to save the login information (e.g. a request signal in response to hold-down of the necessity confirmation button) and the authentication name from the input unit 13, the authentication information addition unit 19 transmits login information (LI) including the authentication server URL (ASU-WP), the authentication information, the user ID and the authentication name to the login history information list server 30, and requests to additionally register it on the login history information list 31. In addition to the authentication server URL (ASU-WP), a web page URL (WPU) of the displayed web page may also be included in the login information (LI) and registered on the login history information list 31. Note that the login information (LI) contains personal data. It is therefore preferable that the authentication information addition unit 19 encrypts and then transmits the login information (LI). The login history information list server 30 receives and restores the encrypted login information (LI). Alternatively, the login history information list server 30 may not restore the encrypted login information (LI). In this case, checking for duplication of the login information and the extension processing are performed not by the login history information list server 30 but by the user terminal 10. If the received login information (LI) is a new one, the login history information list server 30 registers the new login information (LI) on the login history information list 31.

Next, the above-mentioned predetermined criterion (adequacy level determination rule) will be described in more detail. In a case where an authentication server URL completely matches another authentication server URL except for a query part, the adequacy level between the two authentication server URLs is set to the “adequacy level 1”. In a case where an authentication server URL has similarity to another authentication server URL, the adequacy level between the two authentication server URLs is set to the “adequacy level 2” or the “adequacy level 3”. For example, if an authentication server URL matches another authentication server URL at a host level, the adequacy level is set to the “adequacy level 2”. If an authentication server URL matches another authentication server URL at a domain level, the adequacy level is set to the “adequacy level 3”. Otherwise, the adequacy level between the two authentication server URLs is set to the “adequacy level 4”.

The extension unit 15 performs matching of the authentication server URL (ASU-LI) included in the login history information list 31 and the authentication server URL (ASU-SG) included in the service group information list 21. If the adequacy level between the authentication server URL (ASU-LI) and the authentication server URL (ASU-SG) is any of the adequacy levels 1 to 3, the extension unit 15 relates the login information (LI) including the authentication server URL (ASU-LI) to the service group to which the authentication server URL (ASU-SG) belongs.

The adequacy determination unit 17 makes a comparison between an authentication server URL (ASU-WP) included in the data of the displayed web page and authentication server URLs (ASU-LI) included in the login information (LI). If the authentication server URL (ASU-WP) completely matches a certain authentication server URL (ASU-LI), namely, if a certain login information (LI) includes the authentication information that is transmitted in the past to the authentication server URL (ASU-WP), the adequacy determination unit 17 determines that the adequacy level of the certain login information (LI) is the “adequacy level 1”. Moreover, the adequacy determination unit 17 makes a comparison between an authentication server URL (ASU-WP) included in the data of the displayed web page and authentication server URLs (ASU-SG) included in the corresponding service group related to login information (LI). If the authentication server URL (ASU-WP) completely matches a certain authentication server URL (ASU-SG), namely, if a certain login information (LI) is related to the service group including the certain authentication server URL (ASU-SG), the adequacy determination unit 17 determines that the adequacy level of the certain login information (LI) is the “adequacy level 1”.

If the authentication server URL (ASU-WP) has similarity to a certain authentication server URL (ASU-LI), namely, if a certain login information (LI) includes the authentication information that is transmitted in the past to the certain authentication server URL (ASU-LI) similar to the authentication server URL (ASU-WP), the adequacy determination unit 17 determines that the adequacy level of the certain login information (LI) is the “adequacy level 2” or the “adequacy level 3”. Moreover, if the authentication server URL (ASU-WP) has similarity to a certain authentication server URL (ASU-SG), namely, if a certain login information (LI) is related to the service group including the certain authentication server URL (ASU-SG) similar to the authentication server URL (ASU-WP), the adequacy determination unit 17 determines that the adequacy level of the certain login information (LI) is the “adequacy level 2” or the “adequacy level 3”. For example, matching at a host level means the “adequacy level 2” and matching at a domain level means the “adequacy level 3”.

In the other cases, the adequacy determination unit 17 determines that the adequacy level of the login information (LI) is the “adequacy level 4”.

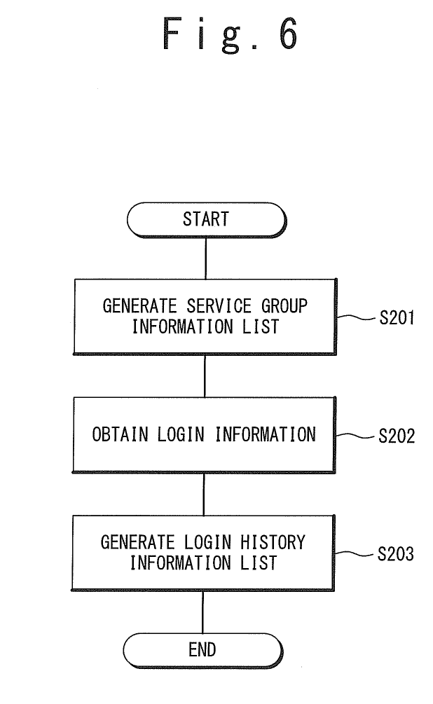

Next, processing by the ID aggregation service system according to the exemplary embodiment will be described below. First, a preliminary processing of the ID aggregation service system will be described with reference to FIG. 6.

(1) Step S201:

Let us consider a case where a plurality of service provides cooperate with each other, and the identical (common) authentication information such as a user ID and a password can be used for authentication with respect to different web pages provided by different service providers. In this case, information of the different web pages are grouped. More specifically, authentication server URLs included in data of the respective web pages are grouped. The group thus created is referred to as a service group. The service group includes the group of authentication server URLs respectively locating the authentication servers that perform authentication with the identical authentication information. The number of the service group can be plural. The service group information list server 20 summarizes information of the service groups in a list form and stores it as the service group information list 21.

(2) Step S202:

A user inputs the user ID and the password into a displayed web page (browser 1). The entry auxiliary software 2 requests the login history information list server 30 to register login information including the authentication server URL included in data of the web page and the input user ID and password on the login history information list 31.

(3) Step S203:

The login history information list server 30 receives the authentication server URL included in data of the web page and the input user ID and password. Then, the login history information list server 30 checks whether or not any of login information already registered on the login history information list 31 has the same user ID and password as those received. If an already-registered login information has the same user ID and password but does not have the same authentication server URL, the login history information list server 30 adds the received authentication server URL to the already-registered login information in the login history information list 31. If there is no already-registered login information having the same user ID and password as those received, the login history information list server 30 generates new login information including the received authentication server URL, user ID and password, and registers the new login information on the login history information list 31. If an already-registered login information has the same authentication server URL, user ID and password as those received, the login history information list server 30 does not generate new login information.

The checking for duplication with regard to the authentication URLs in the login history information list 31 may be performed on the side of the user terminal 10 when the login history information list 31 is downloaded to the user terminal 10. For example, the checking for duplication with regard to the authentication URLs in the login history information list 31 is performed before the user terminal 10 displays the necessity confirmation button as to whether to save the login information in the login history information list server 30.

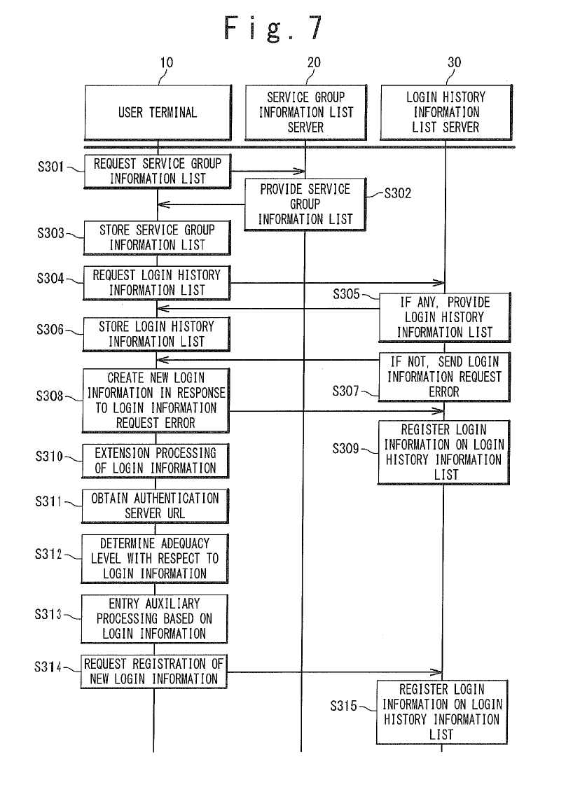

Next, processing by the ID aggregation service system according to the exemplary embodiment will be described in more detail with reference to FIG. 7.

(1) Step S301:

When the user terminal 10 is booted or the entry auxiliary software 2 is activated, the list acquisition unit 14 transmits a service group information list request including the user ID to the service group information list server 20.

(2) Step S302:

When receiving the service group information list request, the service group information list server 20 transmits the service group information list 21 to the user terminal 10 specified by the user ID.

(3) Step S303:

When receiving the service group information list 21 from the service group information list server 20, the list acquisition unit 14 stores the received service group information list 21 in the memory unit 11.

(4) Step S304:

When the user terminal 10 is booted or the entry auxiliary software 2 is activated, the list acquisition unit 14 also transmits a login information request including the user ID to the login history information list server 30.

(5) Step S305:

When receiving the login information request, the login history information list server 30 checks whether or not login information associated with the user ID is included in the login history information list 31. If login information associated with the user ID is included in the login history information list 31, the login history information list server 30 transmits the login history information list 31 associated with the user ID to the user terminal 10 specified by the user ID.

(6) Step S306:

When receiving the login history information list 31 from the login history information list server 30, the list acquisition unit 14 stores the received login history information list 31 in the memory unit 11.

(7) Step S307:

If there is no login information associated with the user ID in the login history information list 31, the login history information list server 30 transmits a login information request error. The login information request error indicates that there is no login information associated with the user ID.

(8) Step S308:

When the list acquisition unit 14 receives the login information request error, the entry auxiliary processing (e.g. input of the authentication information of the “adequacy level 1” into the entry field, display of the entry candidates) is not performed.

The authentication entry detection unit 16 detects an authentication server URL (ASU-WP) included in data of the web page and the input authentication information such as the user ID and password. The authentication information addition unit 19 displays the necessity confirmation button for saving the authentication information in the login history information list server 30 and an entry field used for inputting an authentication name indicating the authentication information on the display unit 12. If the authentication information addition unit 19 detects hold-down of a submit button for transmitting the authentication information to the authentication server 50 and receives the save instruction and the authentication name, the authentication information addition unit 19 transmits login information including the authentication server URL (ASU-WP), the authentication information, the user ID and the authentication name to the login history information list server 30. Consequently, the login history information list 31 including the new login information is generated in the user terminal 10 and the login history information list server 30. A trigger of adding the authentication information is not limited to the detection of the hold-down of the submit button. For example, the trigger can be detection of a HTTP request message to transmit the authentication information to the authentication server 50. For example, in a case of the Basic authentication and the like where the authentication dialog is used, the “detection of the hold-down of the submit button” is employed. In a case of authentication through a web page, the “detection of HTTP request message” is employed. In the case where the “detection of HTTP request message” is employed, the HTTP request message is monitored to analyze whether the HTTP request message indicates transmission of the authentication information. A timing of displaying the necessity confirmation button is arbitrary. For example, the timing can be after the authentication information is transmitted to the authentication server 50 and another web page is displayed.

(9) Step S309:

The login history information list server 30 receives the login information from the user terminal 10 and adds the received login information to the login history information list 31.

(10) Step S310:

The extension unit 15 performs the extension processing with respect to the login information, based on the service group information list 21 and the login history information list 31 stored in the memory unit 11. More specifically, the extension unit 15 compares each of the authentication server URL (ASU-LI) included in the login information in the login history information list 31 with the authentication server URL (ASU-SG) included in the service group information list 21, in accordance with the above-mentioned “adequacy level determination rule”. If the resultant adequacy level is any of the adequacy levels 1 to 3”, the extension unit 15 considers the matched authentication server URL (ASU-LI) to be in the same service group as the matched authentication server URL (ASU-SG) and relates the authentication server URL (ASU-LI) to the corresponding service group. Thus, the login information and the service group are related to each other by the extension processing, and thereby extension-processed login information is obtained. It should be noted that the login history information list server 30 also can perform the above-described extension processing at a time when the login information is stored in the login history information list server 30. In this case, the user terminal 10 just obtains the extension-processed login information.

(11) Step S311:

The browser 1 displays a web page on the display unit 12. When the authentication entry detection unit 16 detects an entry field for authentication information and an authentication server URL (ASU-WP) from the data of the displayed web page, the authentication entry detection unit 16 transmits the authentication server URL (ASU-WP) to the adequacy determination unit 17.

(12) Step S312:

The adequacy determination unit 17 compares the authentication server URL (ASU-WP) with the authentication server URL (ASU-LI) included in the extension-processed login information and the authentication server URL (ASU-SG), in accordance with the above-mentioned “adequacy level determination rule”. Consequently, the adequacy determination unit 17 obtains the adequacy level for each login information and relates the obtained adequacy level to the login information.

(13) Step S313:

The entry auxiliary unit 18 performs the entry auxiliary processing by assisting input of the authentication information included in the login information, based on the adequacy level related to the login information. As to the login information related to the “adequacy level 1”, the entry auxiliary unit 18 automatically inputs the authentication information included in the login information into the entry field for the authentication information on the web page. As to the login information related to the “adequacy level 2” or “adequacy level 3”, the entry auxiliary unit 18 displays the authentication name indicating the authentication information included in the login information as entry candidates on the display unit 12. The user can select one authentication name (authentication information) by using the input unit 13. For example, the authentication name is displayed on a tool bar of the browser 1 or a dialog box. When an authentication name is selected by the input unit 13, the entry auxiliary unit 18 inputs the authentication information indicated by the selected authentication name into the entry field for the authentication information on the web page. As to the login information related to the “adequacy level 4”, the entry auxiliary unit 18 does not input nor display the authentication information included in the login information. The authentication name in the automatically input login information related to the “adequacy level 1” may also be displayed as an entry candidate.

(14) Step S314:

The authentication information addition unit 19 detects hold-down of the submit button for transmitting the authentication information to the authentication server 50. When the authentication information addition unit 19 obtains the authentication server URL (ASU-WP) associated with the web page and the input user ID and password, the authentication information addition unit 19 displays the necessity confirmation button for saving in the login history information list server 30 and the entry field used for inputting an authentication name indicating the authentication information on the display unit 12. When receiving the save instruction and the authentication name, the authentication information addition unit 19 transmits login information (LI) including the authentication server URL (ASU-WP), the authentication information, the user ID and the authentication name to the login history information list server 30. Thus, the login history information list in the user terminal 10 is also updated.

(15) Step S315:

The login history information list server 30 receives the received login information (LI) from the authentication information addition unit 19. The login history information list server 30 registers the received login information (LI) on the login history information list 31. Here, the login history information list server 30 may check whether the received login information is already registered on the login history information list 31. If the received login information (LI) is not yet registered on the login history information list 31, the login history information list server 30 adds the received login information (LI) to the login history information list 31.

The processing may return back to Step S310 after Step S315. For example, it may be possible in a case of the so-called Internet surfing that authentication is made for a certain service, then authentication is made for another service, and thereafter authentication is made for the first one. In this case, the processing returns back to Step S310 after Step S315.

The extension processing with respect to the login information may be performed not only in Step S310 but also in other cases. For example, in a case where the authentication information is transmitted to a new authentication server URL that is not included in the login information in the login history information list 31, the new authentication server URL is added to the login history information list 31 in Step S308, Step S314 or Step S315. In this case, the login information including the new authentication server URL may be newly related to a certain server group. Therefore, the extension processing needs to be performed again after the login history information list 31 is updated. For example, the login history information list 31 is updated when new authentication information is transmitted or the existing authentication information is transmitted to a new authentication server URL and new login information is added.

A timing of performing the extension processing (Step S310) can be when the login history information list server 30 stores the login information. Or, the timing may be when the user terminal 10 downloads the login history information list 31. Alternatively, the timing may be when the login history information list 31 in the login history information list server 30 is updated in Step S314.

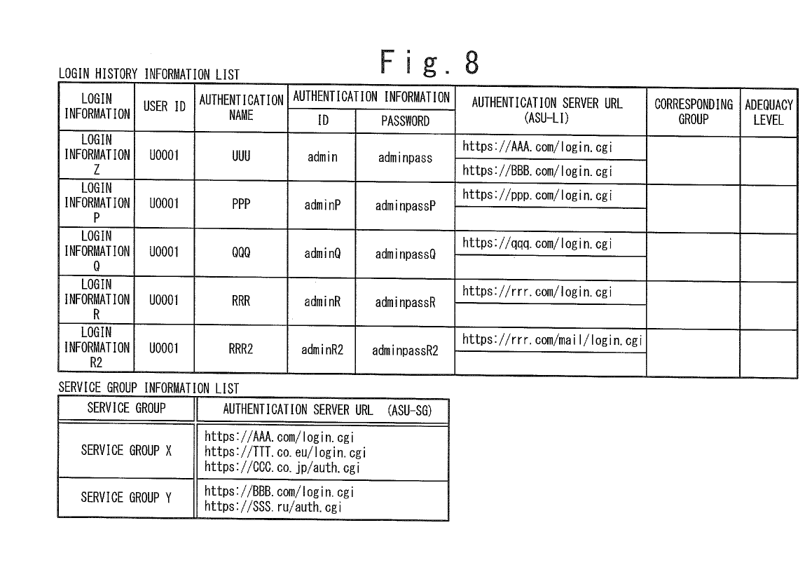

Next, the extension processing, determination of the adequacy level and entry auxiliary processing will be described below in more detail. FIG. 8 shows an example of the login history information list 31 and the service group information list 21.

Next, the extension processing will be explained with reference to FIG. 8. In the extension processing with respect to login information Z, the authentication server URL (ASU-LI) included in the login information Z is compared with the authentication server URL (ASU-SG) included in the service group information list 21, until they matches at any of the adequacy levels 1 to 3 according to the “adequacy level determination rule” or no comparison target remains. In the example, “https://AAA.com/login.cgi” included in the login information Z matches “https://AAA.com/login.cgi” included in the service group X, and therefore the authentication server URL (ASU-LI) “https://AAA.com/login.cgi” is related to the service group X. Next, “https://BBB.com/login.cgi” included in the login information Z is compared with each of “https://AAA.com/login.cgi”, “https://TTT.co.eu/login.cgi” and “https://CCC.co.jp/auth.cgi” included in the service group X, resulting in no matching. Next, “https://BBB.com/login.cgi” included in the login information Z matches “https://BBB.com/login.cgi” included in the service group Y, and therefore the authentication server URL (ASU-LI) “https://BBB.com/login.cgi” is related to the service group Y.

In the extension processing with respect to login information P, the authentication server URL (ASU-LI) included in the login information P is compared with the authentication server URL (ASU-SG) included in the service group information list 21, until they matches at any of the adequacy levels 1 to 3 according to the “adequacy level determination rule” or no comparison target remains. In the example, “https://ppp.com/login.cgi” included in the login information P is compared with each of “https://AAA.com/login.cgi”, “https://TTT.co.eu/login.cgi” and “https://CCC.co.jp/auth.cgi” included in the service group X and “https://BBB.com/login.cgi” and “https://SSS.ru/auth.cgi” included in the service group Y, resulting in no matching. That is, there is no service group associated with the authentication server URL (ASU-LI) included in the login information P.

As in the case of the extension processing with respect to the login information P, the extension processing with respect to login information Q, R and R2 results in no matching. That is, there is no service group associated with the authentication server URL (ASU-LI) included in the login information Q, R and R2.

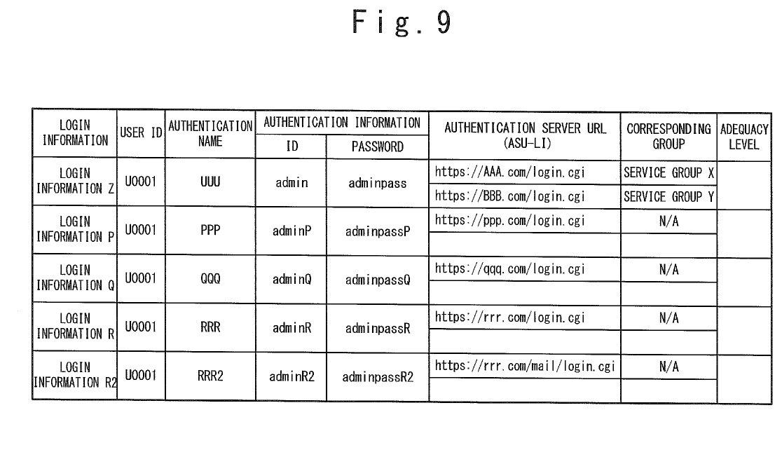

Consequently, the corresponding group 317 in the login history information list 31 is determined. FIG. 9 shows the login history information list 31 in which the above-mentioned result is reflected in the corresponding group 317.

Next, several examples of the adequacy level determination processing and the entry auxiliary processing will be demonstrated with reference to FIGS. 8 and 9.

<Case A> The authentication server URL (ASU-WP) associated with the web page is “https://ppp.com/login.cgi”

In the adequacy level determination processing with respect to the login information Z, the authentication server URL (ASU-WP) is compared with the authentication server URL (ASU-LI) included in the login information Z and the authentication server URL (ASU-SG) included in the service group information list 21, until they matches at the “adequacy level 1” according to the “adequacy level determination rule” or no comparison target remains. In the present example, “https://ppp.com/login.cgi” associated with the web page does not match “https://AAA.com/login.cgi” included in the login information Z, and thus the adequacy level is determined to be the “adequacy level 4”. Also, “https://ppp.com/login.cgi” associated with the web page does not match “https://AAA.com/login.cgi” included in the service group X, and thus the adequacy level is determined to be the “adequacy level 4”. Note here that redundant comparison may arise because the authentication server URL (ASU-LI) matches the authentication server URL (ASU-SG) in the extension processing. Moreover, “https://ppp.com/login.cgi” associated with the web page is compared in a similar manner with each of “https://TTT.co.eu/login.cgi” and “https://CCC.co.jp/auth.cgi” included in the service group X, “https://BBB.com/login.cgi” included in the login information Z, “https://BBB.com/login.cgi” and “https://SSS.ru/auth.cgi” included in the service group Y, resulting in the “adequacy level 4” respectively. Since the highest adequacy level among the obtained adequacy levels is the “adequacy level 4”, the adequacy level of the login information Z is determined to be the “adequacy level 4”.

In the adequacy level determination processing with respect to the login information P, the authentication server URL (ASU-WP) is compared with the authentication server URL (ASU-LI) included in the login information P and the authentication server URL (ASU-SG) included in the service group information list 21, until they matches at the “adequacy level 1” according to the “adequacy level determination rule” or no comparison target remains. In the present example, “https://ppp.com/login.cgi” associated with the web page completely matches “https://ppp.com/login.cgi” included in the login information P, and thus the adequacy level is determined to be the “adequacy level 1”. Since the highest adequacy level among the obtained adequacy levels is the “adequacy level 1”, the adequacy level of the login information P is determined to be the “adequacy level 1”.

In the adequacy level determination processing with respect to the login information Q, the authentication server URL (ASU-WP) is compared with the authentication server URL (ASU-LI) included in the login information Q and the authentication server URL (ASU-SG) included in the service group information list 21, until they matches at the “adequacy level 1” according to the “adequacy level determination rule” or no comparison target remains. In the present example, “https://ppp.com/login.cgi” associated with the web page does not match “https://qqq.com/login.cgi” included in the login information Q, and thus the adequacy level is determined to be the “adequacy level 4”. Since the highest adequacy level among the obtained adequacy levels is the “adequacy level 4”, the adequacy level of the login information Q is determined to be the “adequacy level 4”.

In the adequacy level determination processing with respect to the login information R, the authentication server URL (ASU-WP) is compared with the authentication server URL (ASU-LI) included in the login information R and the authentication server URL (ASU-SG) included in the service group information list 21, until they matches at the “adequacy level 1” according to the “adequacy level determination rule” or no comparison target remains. In the present example, “https://ppp.com/login.cgi” associated with the web page does not match “https://rrr.com/login.cgi” included in the login information R, and thus the adequacy level is determined to be the “adequacy level 4”. Since the highest adequacy level among the obtained adequacy levels is the “adequacy level 4”, the adequacy level of the login information R is determined to be the “adequacy level 4”.

In the adequacy level determination processing with respect to the login information R2, the authentication server URL (ASU-WP) is compared with the authentication server URL (ASU-LI) included in the login information R2 and the authentication server URL (ASU-SG) included in the service group information list 21, until they matches at the “adequacy level 1” according to the “adequacy level determination rule” or no comparison target remains. In the present example, “https://ppp.com/login.cgi” associated with the web page does not match “https://rrr.com/mail/login.cgi” included in the login information R2, and thus the adequacy level is determined to be the “adequacy level 4”. Since the highest adequacy level among the obtained adequacy levels is the “adequacy level 4”, the adequacy level of the login information R2 is determined to be the “adequacy level 4”.

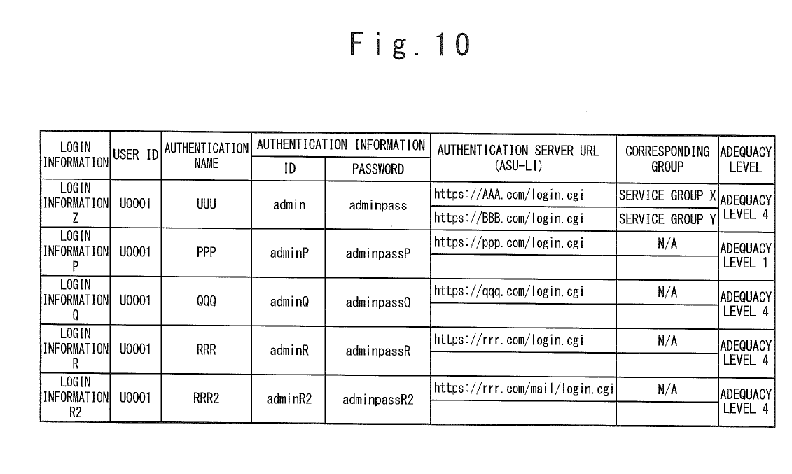

In this manner, the adequacy level 318 in the login history information list 31 is determined in the case of the <Case A>. FIG. 10 shows the login history information list 31 in which the above-mentioned result is reflected in the adequacy level 318.

Based on the result shown in FIG. 10, the entry auxiliary unit 18 inputs the authentication information included in the login information (login information P) of the “adequacy level 1” into the entry field for the authentication information on the web page. In the present example, the entry auxiliary unit 18 inputs “adminp” and “adminpassp” into the ID entry field and the password entry field on the web page, respectively, with reference to the authentication information included in the login information P.

<Case B> The authentication server URL (ASU-WP) associated with the web page is “https://ppp.com/mail/mailauth.cgi”

In the adequacy level determination processing with respect to the login information Z, the authentication server URL (ASU-WP) is compared with the authentication server URL (ASU-LI) included in the login information Z and the authentication server URL (ASU-SG) included in the service group information list 21, until they matches at the “adequacy level 1” according to the “adequacy level determination rule” or no comparison target remains. In the present example, “https://ppp.com/mail/mailauth.cgi” associated with the web page does not match “https://AAA.com/login.cgi” included in the login information Z, and thus the adequacy level is determined to be the “adequacy level 4”. Also, “https://ppp.com/mail/mailauth.cgi” associated with the web page does not match “https://AAA.com/login.cgi” included in the service group X, and thus the adequacy level is determined to be the “adequacy level 4”. Note here that redundant comparison may arise because the authentication server URL (ASU-LI) matches the authentication server URL (ASU-SG) in the extension processing. Moreover, “https://ppp.com/mail/mailauth.cgi” associated with the web page is compared in a similar manner with each of “https://TTT.co.eu/login.cgi” and “https://CCC.co.jp/auth.cgi” included in the service group X, “https://BBB.com/login.cgi” included in the login information Z, “https://BBB.com/login.cgi” and “https://SSS.ru/auth.cgi” included in the service group Y, resulting in the “adequacy level 4” respectively. Since the highest adequacy level among the obtained adequacy levels is the “adequacy level 4”, the adequacy level of the login information Z is determined to be the “adequacy level 4”.

In the adequacy level determination processing with respect to the login information P, the authentication server URL (ASU-WP) is compared with the authentication server URL (ASU-LI) included in the login information P and the authentication server URL (ASU-SG) included in the service group information list 21, until they matches at the “adequacy level 1” according to the “adequacy level determination rule” or no comparison target remains. In the present example, “https://ppp.com/mail/mailauth.cgi” associated with the web page matches “https://ppp.com/login.cgi” included in the login information P at the host level according to the “adequacy level determination rule”, and thus the adequacy level is determined to be the “adequacy level 2”. Since the highest adequacy level among the obtained adequacy levels is the “adequacy level 2”, the adequacy level of the login information P is determined to be the “adequacy level 2”.

In the adequacy level determination processing with respect to the login information Q, the authentication server URL (ASU-WP) is compared with the authentication server URL (ASU-LI) included in the login information Q and the authentication server URL (ASU-SG) included in the service group information list 21, until they matches at the “adequacy level 1” according to the “adequacy level determination rule” or no comparison target remains. In the present example, “https://ppp.com/mail/mailauth.cgi” associated with the web page does not match “https://qqq.com/login.cgi” included in the login information Q, and thus the adequacy level is determined to be the “adequacy level 4”. Since the highest adequacy level among the obtained adequacy levels is the “adequacy level 4”, the adequacy level of the login information Q is determined to be the “adequacy level 4”.

In the adequacy level determination processing with respect to the login information R, the authentication server URL (ASU-WP) is compared with the authentication server URL (ASU-LI) included in the login information R and the authentication server URL (ASU-SG) included in the service group information list 21, until they matches at the “adequacy level 1” according to the “adequacy level determination rule” or no comparison target remains. In the present example, “https://ppp.com/mail/mailauth.cgi” associated with the web page does not match “https://rrr.com/login.cgi” included in the login information R, and thus the adequacy level is determined to be the “adequacy level 4”. Since the highest adequacy level among the obtained adequacy levels is the “adequacy level 4”, the adequacy level of the login information R is determined to be the “adequacy level 4”.

In the adequacy level determination processing with respect to the login information R2, the authentication server URL (ASU-WP) is compared with the authentication server URL (ASU-LI) included in the login information R2 and the authentication server URL (ASU-SG) included in the service group information list 21, until they matches at the “adequacy level 1” according to the “adequacy level determination rule” or no comparison target remains. In the present example, “https://ppp.com/mail/mailauth.cgi” associated with the web page does not match “https://rrr.com/mail/login.cgi” included in the login information R2, and thus the adequacy level is determined to be the “adequacy level 4”. Since the highest adequacy level among the obtained adequacy levels is the “adequacy level 4”, the adequacy level of the login information R2 is determined to be the “adequacy level 4”.

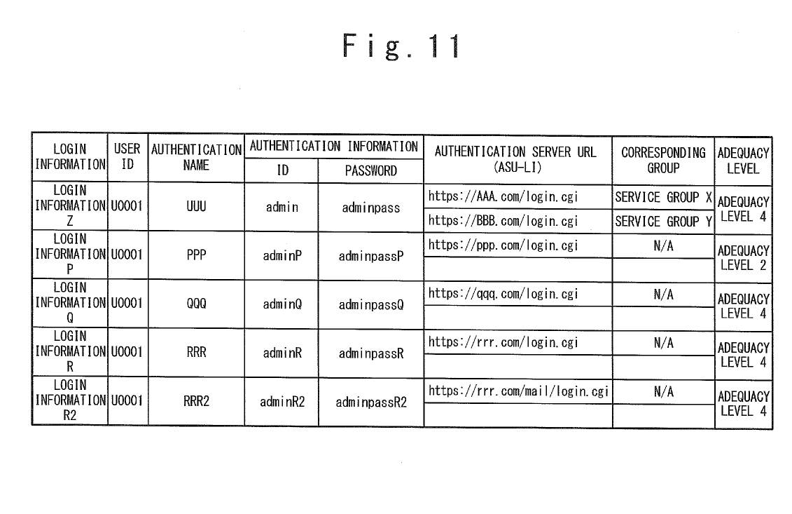

In this manner, the adequacy level 318 in the login history information list 31 is determined in the case of the <Case B>. FIG. 11 shows the login history information list 31 in which the above-mentioned result is reflected in the adequacy level 318.

Based on the result shown in FIG. 11, the entry auxiliary unit 18 displays entry candidates of the authentication information included in the login information of the adequacy levels 1 to 3 near the entry field for the authentication information on the web page. In the present example, the automatic input of the authentication information is not carried out, because there is no login information of the “adequacy level 1”. Instead, since there is the login information (login information P) of the “adequacy level 2”, the authentication information name (authentication name) related to the “adequacy level 2” is displayed as the entry candidates. For example, a button representing the authentication name such as “Page of PPP” is displayed on the dialog. If the button is held down, the entry auxiliary unit 18 judges that the authentication name indicating the authentication information is selected as an entry. When the entry is thus selected by the user, the entry auxiliary unit 18 inputs “adminp” and “adminpassp” into the ID entry field and the password entry field on the web page, respectively, with reference to the authentication information included in the login information P.

<Case C> The authentication server URL (ASU-WP) associated with the web page is “https://SSS.ru/auth.cgi”

In the adequacy level determination processing with respect to the login information Z, the authentication server URL (ASU-WP) is compared with the authentication server URL (ASU-LI) included in the login information Z and the authentication server URL (ASU-SG) included in the service group information list 21, until they matches at the “adequacy level 1” according to the “adequacy level determination rule” or no comparison target remains. In the present example, “https://SSS.ru/auth.cgi” associated with the web page does not match “https://AAA.com/login.cgi” included in the login information Z, and thus the adequacy level is determined to be the “adequacy level 4”. Also, “https://SSS.ru/auth.cgi” associated with the web page does not match “https://AAA.com/login.cgi” included in the service group X, and thus the adequacy level is determined to be the “adequacy level 4”. Note here that redundant comparison may arise because the authentication server URL (ASU-LI) matches the authentication server URL (ASU-SG) in the extension processing. Moreover, “https://SSS.ru/auth.cgi” associated with the web page is compared in a similar manner with each of “https://TTT.co.eu/login.cgi” and “https://CCC.co.jp/auth.cgi” included in the service group X and “https://BBB.com/login.cgi” included in the login information Z, resulting in the “adequacy level 4” respectively. However, “https://SSS.ru/auth.cgi” associated with the web page completely matches “https://SSS.ru/auth.cgi” included in the service group Y, and thus the adequacy level is determined to be the “adequacy level 1”. Since the highest adequacy level among the obtained adequacy levels is the “adequacy level 1”, the adequacy level of the login information Z is determined to be the “adequacy level 1”.

In the adequacy level determination processing with respect to the login information P, the authentication server URL (ASU-WP) is compared with the authentication server URL (ASU-LI) included in the login information P and the authentication server URL (ASU-SG) included in the service group information list 21, until they matches at the “adequacy level 1” according to the “adequacy level determination rule” or no comparison target remains. In the present example, “https://SSS.ru/auth.cgi” associated with the web page does not match “https://ppp.com/login.cgi” included in the login information P, and thus the adequacy level is determined to be the “adequacy level 4”. Since the highest adequacy level among the obtained adequacy levels is the “adequacy level 4”, the adequacy level of the login information P is determined to be the “adequacy level 4”.

In the adequacy level determination processing with respect to the login information Q, the authentication server URL (ASU-WP) is compared with the authentication server URL (ASU-LI) included in the login information Q and the authentication server URL (ASU-SG) included in the service group information list 21, until they matches at the “adequacy level 1” according to the “adequacy level determination rule” or no comparison target remains. In the present example, “https://SSS.ru/auth.cgi” associated with the web page does not match “https://qqq.com/login.cgi” included in the login information Q, and thus the adequacy level is determined to be the “adequacy level 4”. Since the highest adequacy level among the obtained adequacy levels is the “adequacy level 4”, the adequacy level of the login information Q is determined to be the “adequacy level 4”.

In the adequacy level determination processing with respect to the login information R, the authentication server URL (ASU-WP) is compared with the authentication server URL (ASU-LI) included in the login information R and the authentication server URL (ASU-SG) included in the service group information list 21, until they matches at the “adequacy level 1” according to the “adequacy level determination rule” or no comparison target remains. In the present example, “https://SSS.ru/auth.cgi” associated with the web page does not match “https://rrr.com/login.cgi” included in the login information R, and thus the adequacy level is determined to be the “adequacy level 4”. Since the highest adequacy level among the obtained adequacy levels is the “adequacy level 4”, the adequacy level of the login information R is determined to be the “adequacy level 4”.

In the adequacy level determination processing with respect to the login information R2, the authentication server URL (ASU-WP) is compared with the authentication server URL (ASU-LI) included in the login information R2 and the authentication server URL (ASU-SG) included in the service group information list 21, until they matches at the “adequacy level 1” according to the “adequacy level determination rule” or no comparison target remains. In the present example, “https://SSS.ru/auth.cgi” associated with the web page does not match “https://rrr.com/mail/login.cgi” included in the login information R2, and thus the adequacy level is determined to be the “adequacy level 4”. Since the highest adequacy level among the obtained adequacy levels is the “adequacy level 4”, the adequacy level of the login information R2 is determined to be the “adequacy level 4”.

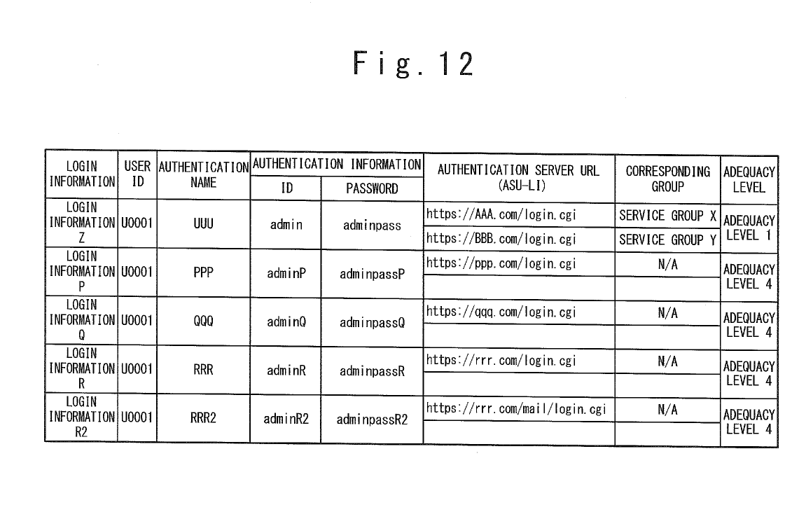

In this manner, the adequacy level 318 in the login history information list 31 is determined in the case of the <Case C>. FIG. 12 shows the login history information list 31 in which the above-mentioned result is reflected in the adequacy level 318.

Based on the result shown in FIG. 12, the entry auxiliary unit 18 inputs the authentication information included in the login information (login information Z) of the “adequacy level 1” into the entry field for the authentication information on the web page. In the present example, the entry auxiliary unit 18 inputs “admin” and “adminpass” into the ID entry field and the password entry field on the web page, respectively, with reference to the authentication information included in the login information Z.

<Case D> The authentication server URL (ASU-WP) associated with the web page is “https://rrr.com/login.cgi”

In the adequacy level determination processing with respect to the login information Z, the authentication server URL (ASU-WP) is compared with the authentication server URL (ASU-LI) included in the login information Z and the authentication server URL (ASU-SG) included in the service group information list 21, until they matches at the “adequacy level 1” according to the “adequacy level determination rule” or no comparison target remains. In the present example, “https://rrr.com/login.cgi” associated with the web page does not match “https://AAA.com/login.cgi” included in the login information Z, and thus the adequacy level is determined to be the “adequacy level 4”. Also, “https://rrr.com/login.cgi” associated with the web page does not match “https://AAA.com/login.cgi” included in the service group X, and thus the adequacy level is determined to be the “adequacy level 4”. Note here that redundant comparison may arise because the authentication server URL (ASU-LI) matches the authentication server URL (ASU-SG) in the extension processing. Moreover, “https://rrr.com/login.cgi” associated with the web page is compared in a similar manner with each of “https://TTT.co.eu/login.cgi” and “https://CCC.co.jp/auth.cgi” included in the service group X, “https://BBB.com/login.cgi” included in the login information Z, “https://BBB.com/login.cgi” and “https://SSS.ru/auth.cgi” included in the service group Y, resulting in the “adequacy level 4” respectively. Since the highest adequacy level among the obtained adequacy levels is the “adequacy level 4”, the adequacy level of the login information Z is determined to be the “adequacy level 4”.

In the adequacy level determination processing with respect to the login information P, the authentication server URL (ASU-WP) is compared with the authentication server URL (ASU-LI) included in the login information P and the authentication server URL (ASU-SG) included in the service group information list 21, until they matches at the “adequacy level 1” according to the “adequacy level determination rule” or no comparison target remains. In the present example, “https://rrr.com/login.cgi” associated with the web page does not match “https://ppp.com/login.cgi” included in the login information P, and thus the adequacy level is determined to be the “adequacy level 4”. Since the highest adequacy level among the obtained adequacy levels is the “adequacy level 4”, the adequacy level of the login information P is determined to be the “adequacy level 4”.

In the adequacy level determination processing with respect to the login information Q, the authentication server URL (ASU-WP) is compared with the authentication server URL (ASU-LI) included in the login information Q and the authentication server URL (ASU-SG) included in the service group information list 21, until they matches at the “adequacy level 1” according to the “adequacy level determination rule” or no comparison target remains. In the present example, “https://rrr.com/login.cgi” associated with the web page does not match “https://qqq.com/login.cgi” included in the login information Q, and thus the adequacy level is determined to be the “adequacy level 4”. Since the highest adequacy level among the obtained adequacy levels is the “adequacy level 4”, the adequacy level of the login information Q is determined to be the “adequacy level 4”.

In the adequacy level determination processing with respect to the login information R, the authentication server URL (ASU-WP) is compared with the authentication server URL (ASU-LI) included in the login information R and the authentication server URL (ASU-SG) included in the service group information list 21, until they matches at the “adequacy level 1” according to the “adequacy level determination rule” or no comparison target remains. In the present example, “https://rrr.com/login.cgi” associated with the web page completely matches “https://rrr.com/login.cgi” included in the login information R, and thus the adequacy level is determined to be the “adequacy level 1”. Since the highest adequacy level among the obtained adequacy levels is the “adequacy level 1”, the adequacy level of the login information R is determined to be the “adequacy level 1”.

In the adequacy level determination processing with respect to the login information R2, the authentication server URL (ASU-WP) is compared with the authentication server URL (ASU-LI) included in the login information R2 and the authentication server URL (ASU-SG) included in the service group information list 21, until they matches at the “adequacy level 1” according to the “adequacy level determination rule” or no comparison target remains. In the present example, “https://rrr.com/login.cgi” associated with the web page matches “https://rrr.com/mail/login.cgi” included in the login information R2 at the host level according to the “adequacy level determination rule”, and thus the adequacy level is determined to be the “adequacy level 2”. Since the highest adequacy level among the obtained adequacy levels is the “adequacy level 2”, the adequacy level of the login information R2 is determined to be the “adequacy level 2”.

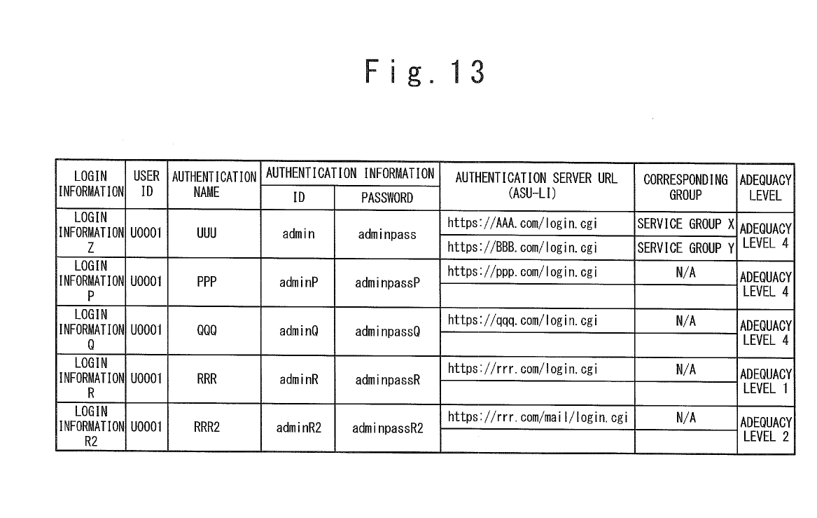

In this manner, the adequacy level 318 in the login history information list 31 is determined in the case of the <Case D>. FIG. 13 shows the login history information list 31 in which the above-mentioned result is reflected in the adequacy level 318.

Based on the result shown in FIG. 13, the entry auxiliary unit 18 inputs the authentication information included in the login information (login information R) of the “adequacy level 1” into the entry field for the authentication information on the web page. Moreover, based on the result shown in FIG. 13, the entry auxiliary unit 18 displays entry candidates of the authentication information included in the login information of the adequacy levels 1 to 3. In the present example, the entry auxiliary unit 18 inputs “adminR” and “adminpassR” into the ID entry field and the password entry field on the web page, respectively, with reference to the authentication information included in the login information R. Moreover, since there is the login information (login information R2) of the “adequacy level 2”, the entry auxiliary unit 18 displays the authentication information names (authentication names) related to the “adequacy level 1” and the “adequacy level 2” as the entry candidates. For example, buttons representing the authentication names such as “Page of RRR” and “Page of RRR2” are displayed on the dialog. If the button of “Page of RRR2” is held down, the entry auxiliary unit 18 judges that the authentication name indicating the authentication information of the login information R2 is selected as an entry. When the authentication name associated with the login information R2 is selected as the entry by the user, the entry auxiliary unit 18 inputs “adminR2” and “adminpassR2” into the ID entry field and the password entry field on the web page, respectively, with reference to the authentication information included in the login information R2.

According to the exemplary embodiment, as described above, the number of authentication server URLs (ASU-LI) can be increased by the extension processing where the login information is related to a service group. In the exemplary embodiment, a field of the corresponding service group is added to the login information and thus the login information is extended. The extension processing can be performed in advance before an authentication server URL (ASU-WP) is obtained from data of a web page. For example, the extension processing may be performed at the time when the login information is stored in the memory unit 11 of the user terminal 10. In this case, high-speed processing becomes possible.

Alternatively, the number of authentication server URLs (ASU-WP) can be increased by specifying a service group associated with the authentication server URL.

For example, in the foregoing <Case C>, the authentication server URL (ASU-WP) is compared with the authentication server URL (ASU-SG) included in the service groups X and Y. In the present example, “https://SSS.ru/auth.cgi” associated with the web page is compared with each of “https://AAA.com/login.cgi”, “https://TTT.co.eu/login.cgi” and “https://CCC.co.jp/auth.cgi” included in the service group X, resulting in no matching. However, “https://SSS.ru/auth.cgi” associated with the web page completely matches “https://SSS.ru/auth.cgi” included in the service group Y. Since the authentication server URL (ASU-WP) matches the authentication server URL (ASU-SG) included in the service group Y, the service group corresponding to the authentication server URL (ASU-WP) is set to the “service group Y”.

Next, the authentication server URL (ASU-WP) is compared with the authentication server URL (ASU-LI) included in the login information Z. In the present example, “https://SSS.ru/auth.cgi” associated with the web page does not match “https://AAA.com/login.cgi” included in the login information Z, and thus the adequacy level is determined to be the “adequacy level 4”. Also, “https://SSS.ru/auth.cgi” associated with the web page does not match “https://BBB.com/login.cgi” included in the login information Z, and thus the adequacy level is determined to be the “adequacy level 4”. Moreover, the authentication server URL (ASU-LI) included in the login information Z is compared with the authentication server URL (ASU-SG) included in the service group Y corresponding to the authentication server URL (ASU-WP). In the present example, “https://AAA.com/login.cgi” included in the login information Z does not match “https://BBB.com/login.cgi” and “https://SSS.ru/auth.cgi” included in the service group Y, and thus the adequacy level is determined to be the “adequacy level 4”. However, “https://BBB.com/login.cgi” included in the login information Z completely matches “https://BBB.com/login.cgi” included in the service group Y, and thus the adequacy level is determined to be the “adequacy level 1” according to the “adequacy level determination rule”. Since the highest adequacy level among the obtained adequacy levels is the “adequacy level 1”, the adequacy level of the login information Z is determined to be the “adequacy level 1”.

Next, the authentication server URL (ASU-WP) is compared with the authentication server URL (ASU-LI) included in the login information P. In the present example, “https://SSS.ru/auth.cgi” associated with the web page does not match “https://ppp.com/login.cgi” included in the login information P, and thus the adequacy level is determined to be the “adequacy level 4”. Moreover, the authentication server URL (ASU-LI) included in the login information P is compared with the authentication server URL (ASU-SG) included in the service group Y corresponding to the authentication server URL (ASU-WP). In the present example, “https://ppp.com/login.cgi” included in the login information P does not match “https://BBB.com/login.cgi” and “https://SSS.ru/auth.cgi” included in the service group Y, and thus the adequacy level is determined to be the “adequacy level 4”. Since the highest adequacy level among the obtained adequacy levels is the “adequacy level 4”, the adequacy level of the login information P is determined to be the “adequacy level 4”.

Next, the authentication server URL (ASU-WP) is compared with the authentication server URL (ASU-LI) included in the login information Q, R and R2. The adequacy level determination processing with respect to each of the login information Q, R and R2 is similar to that with respect to the login information P. Since the highest adequacy level among the obtained adequacy levels is the “adequacy level 4”, the adequacy level of each of the login information Q, R and R2 is determined to be the “adequacy level 4”.

Then, the entry auxiliary unit 18 inputs the authentication information included in the login information (login information Z) of the “adequacy level 1” into the entry field for the authentication information on the web page. In the present example, the entry auxiliary unit 18 inputs “admin” and “adminpass” into the ID entry field and the password entry field on the web page, respectively, with reference to the authentication information included in the login information Z.

It should be noted that the user ID and password are used as the authentication information in the foregoing embodiment. However, the authentication information is not limited to that. For example, in a case of biometric authentication or authentication by the use of QR code (registered trademark) or an ID card, appropriate authentication information is used instead of the user ID and password.

Application of the present invention is not limited to the entry auxiliary processing for the authentication information. The present invention can also be applied to entry auxiliary processing for a search keyword that is frequently input in similar search sites or for a specific term that is frequently input in a plurality of web mail sites or weblog sites. In these cases, an URL locating a destination server of the search keyword data or the term data is used instead of the authentication server URL.

The entry auxiliary software according to the exemplary embodiment may be uses as a resident process operating in the background or a plug-in or a tool bar of the browser. Whether or not to activate the entry auxiliary software may depend on a result of authentication by a boot program that is resident in a personal computer. The boot program may perform the authentication by communicating with a server of a provider providing the user with the entry auxiliary software through a network.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. An entry auxiliary apparatus comprising:
an authentication entry detection unit configured to detect a first authentication server URL included in data of a web page displayed, wherein said first authentication server URL locates an authentication server that authenticate users;
an adequacy determination unit configured to compare said first authentication server URL with a second authentication server URL included in login information indicating an input history of authentication information of a user and a third authentication server URL, and to relate said login information to an adequacy level depending on a result of the comparison, wherein a service group includes a group of authentication server URLs locating authentication servers that authenticate with an identical authentication information, said login information is related to said service group, and said third authentication server URL is included in said service group; and
an entry auxiliary unit configured to assist input of authentication information into said web page based on said login information and said adequacy level.

2. The entry auxiliary apparatus according to claim 1, further comprising: an extension unit configured to make a comparison between said second authentication server URL and said third authentication server URL and to relate said second authentication server URL in said login information to said service group if said second authentication server URL matches said third authentication server URL.

3. The entry auxiliary apparatus according to claim 2,
wherein said adequacy determination unit makes a comparison between said first authentication server URL and said second authentication server URL,
said adequacy determination unit relates said login information to a first adequacy level as said adequacy level if said first authentication server URL completely matches said second authentication server URL,
said adequacy determination unit relates said login information to a second adequacy level as said adequacy level if said first authentication server URL matches said second authentication server URL at a host level,
said adequacy determination unit relates said login information to a third adequacy level as said adequacy level if said first authentication server URL matches said second authentication server URL at a domain level, and
said adequacy determination unit relates said login information to a fourth adequacy level as said adequacy level if said first authentication server URL does not match said second authentication server URL.

4. The entry auxiliary apparatus according to claim 3,
wherein said entry auxiliary unit automatically inputs authentication information included in said login information into an entry field for authentication information on said web page if said login information is related to said first adequacy level, and
said entry auxiliary unit displays authentication name indicating authentication information included in said login information if said login information is related to said second adequacy level or said third adequacy level,
wherein when said displayed authentication name is selected, said entry auxiliary unit inputs authentication information indicated by said selected authentication name into an entry field for authentication information on said web page.

5. The entry auxiliary apparatus according to claim 2,
wherein when said second authentication server URL matches said third authentication server URL, said adequacy determination unit sets said second authentication server URL and said third authentication server URL related to said service group as an identical group authentication server URL,
said adequacy determination unit makes a comparison between said first authentication server URL and said identical group authentication server URL,
said adequacy determination unit relates said login information to a first adequacy level as said adequacy level if said first authentication server URL completely matches said identical group authentication server URL,
said adequacy determination unit relates said login information to a second adequacy level as said adequacy level if said first authentication server URL matches said identical group authentication server URL at a host level,
said adequacy determination unit relates said login information to a third adequacy level as said adequacy level if said first authentication server URL matches said identical group authentication server URL at a domain level, and
said adequacy determination unit relates said login information to a fourth adequacy level as said adequacy level if said first authentication server URL does not match said identical group authentication server URL.

6. The entry auxiliary apparatus according to claim 5,
wherein said entry auxiliary unit automatically input authentication information included in said login information into an entry field for authentication information on said web page if said login information is related to said first adequacy level, and
said entry auxiliary unit displays authentication name indicating authentication information included in said login information if said login information is related to said second adequacy level or said third adequacy level,
wherein when said displayed authentication name is selected, said entry auxiliary unit inputs authentication information indicated by said selected authentication name into an entry field for authentication information on said web page.

7. An entry auxiliary system comprising:
a user terminal;
a login history information list server configured to manage a login history information list that includes login information indicating an input history of authentication information of a user; and
a service group information list server configured to manage a service group information list that includes a service group, wherein said service group includes a group of authentication server URLs locating authentication servers that authenticate with an identical authentication information,
wherein said user terminal obtains said login history information list and said service group information list,
said user terminal relates said login information to said service group,
said user terminal detects a first authentication server URL included in data of a web page displayed, wherein said first authentication server URL locates an authentication server that authenticate users,
said user terminal compares said first authentication server URL with a second authentication server URL included in said login information and a third authentication server URL included in said service group,
said user terminal relates said login information to an adequacy level depending on a result of the comparison, and
said user terminal assists input of authentication information into said web page based on said login information and said adequacy level.

8. The entry auxiliary system according to claim 7,
wherein said user terminal makes a comparison between said second authentication server URL and said third authentication server URL, and relates said second authentication server URL in said login information to said service group if said second authentication server URL matches said third authentication server URL.

9. The entry auxiliary system according to claim 8,
wherein said user terminal makes a comparison between said first authentication server URL and said second authentication server URL,
said user terminal relates said login information to a first adequacy level as said adequacy level if said first authentication server URL completely matches said second authentication server URL,
said user terminal relates said login information to a second adequacy level as said adequacy level if said first authentication server URL matches said second authentication server URL at a host level,
said user terminal relates said login information to a third adequacy level as said adequacy level if said first authentication server URL matches said second authentication server URL at a domain level, and
said user terminal relates said login information to a fourth adequacy level as said adequacy level if said first authentication server URL does not match said second authentication server URL.

10. The entry auxiliary system according to claim 9,
wherein said user terminal automatically inputs authentication information included in said login information into an entry field for authentication information on said web page if said login information is related to said first adequacy level, and
said user terminal displays authentication name indicating authentication information included in said login information if said login information is related to said second adequacy level or said third adequacy level,
wherein when said displayed authentication name is selected, said user terminal inputs authentication information indicated by said selected authentication name into an entry field for authentication information on said web page.

11. The entry auxiliary system according to claim 8,
wherein when said second authentication server URL matches said third authentication server URL, said user terminal sets said second authentication server URL and said third authentication server URL related to said service group as an identical group authentication server URL,
said user terminal makes a comparison between said first authentication server URL and said identical group authentication server URL,
said user terminal relates said login information to a first adequacy level as said adequacy level if said first authentication server URL completely matches said identical group authentication server URL,
said user terminal relates said login information to a second adequacy level as said adequacy level if said first authentication server URL matches said identical group authentication server URL at a host level,
said user terminal relates said login information to a third adequacy level as said adequacy level if said first authentication server URL matches said identical group authentication server URL at a domain level, and
said user terminal relates said login information to a fourth adequacy level as said adequacy level if said first authentication server URL does not match said identical group authentication server URL.

12. The entry auxiliary system according to claim 11,
wherein said user terminal automatically inputs authentication information included in said login information into an entry field for authentication information on said web page if said login information is related to said first adequacy level, and
said user terminal displays authentication name indicating authentication information included in said login information if said login information is related to said second adequacy level or said third adequacy level,
wherein when said displayed authentication name is selected, said user terminal inputs authentication information indicated by said selected authentication name into an entry field for authentication information on said web page.

13. An entry auxiliary method comprising:
detecting a first authentication server URL included in data of a web page displayed, wherein said first authentication server URL locates an authentication server that authenticate users;
comparing said first authentication server URL with a second authentication server URL included in login information indicating an input history of authentication information of a user and a third authentication server URL, wherein a service group includes a group of authentication server URLs locating authentication servers that authenticate with an identical authentication information, said login information is related to said service group, and said third authentication server URL is included in said service group;
relating said login information to an adequacy level depending on a result of said comparing; and
assisting input of authentication information into said web page based on said login information and said adequacy level.

14. The entry auxiliary method according to claim 13, further comprising: making a comparison between said second authentication server URL and said third authentication server URL to relate said second authentication server URL in said login information to said service group if said second authentication server URL matches said third authentication server URL.

15. The entry auxiliary method according to claim 14,
wherein said comparing comprises: making a comparison between said first authentication server URL and said second authentication server URL,
wherein said relating comprises:
relating said login information to a first adequacy level as said adequacy level, if said first authentication server URL completely matches said second authentication server URL;
relating said login information to a second adequacy level as said adequacy level, if said first authentication server URL matches said second authentication server URL at a host level;
relating said login information to a third adequacy level as said adequacy level, if said first authentication server URL matches said second authentication server URL at a domain level; and
relating said login information to a fourth adequacy level as said adequacy level, if said first authentication server URL does not match said second authentication server URL.

16. The entry auxiliary method according to claim 15,
wherein said assisting comprises:
automatically inputting authentication information included in said login information into an entry field for authentication information on said web page, if said login information is related to said first adequacy level; and
displaying authentication name indicating authentication information included in said login information, if said login information is related to said second adequacy level or said third adequacy level,
wherein when said displayed authentication name is selected, said assisting further comprises: inputting authentication information indicated by said selected authentication name into an entry field for authentication information on said web page.

17. The entry auxiliary method according to claim 14,
wherein when said second authentication server URL matches said third authentication server URL, said second authentication server URL and said third authentication server URL related to said service group are set as an identical group authentication server URL,
wherein said comparing comprises: making a comparison between said first authentication server URL and said identical group authentication server URL,
wherein said relating comprises:
relating said login information to a first adequacy level as said adequacy level, if said first authentication server URL completely matches said identical group authentication server URL;
relating said login information to a second adequacy level as said adequacy level, if said first authentication server URL matches said identical group authentication server URL at a host level;
relating said login information to a third adequacy level as said adequacy level, if said first authentication server URL matches said identical group authentication server URL at a domain level; and
relating said login information to a fourth adequacy level as said adequacy level, if said first authentication server URL does not match said identical group authentication server URL.

18. The entry auxiliary method according to claim 17,
wherein said assisting comprises:
automatically inputting authentication information included in said login information into an entry field for authentication information on said web page, if said login information is related to said first adequacy level; and
displaying authentication name indicating authentication information included in said login information, if said login information is related to said second adequacy level or said third adequacy level,
wherein when said displayed authentication name is selected, said assisting further comprises: inputting authentication information indicated by said selected authentication name into an entry field for authentication information on said web page.

19. An entry auxiliary program recorded on a computer-readable medium that, when executed, causes a computer to perform an entry auxiliary method comprising:
detecting a first authentication server URL included in data of a web page displayed, wherein said first authentication server URL locates an authentication server that authenticate users;
comparing said first authentication server URL with a second authentication server URL included in login information indicating an input history of authentication information of a user and a third authentication server URL, wherein a service group includes a group of authentication server URLs locating authentication servers that authenticate with an identical authentication information, said login information is related to said service group, and said third authentication server URL is included in said service group;
relating said login information to an adequacy level depending on a result of said comparing; and
assisting input of authentication information into said web page based on said login information and said adequacy level.

20. The entry auxiliary program according to claim 19,
wherein said entry auxiliary method further comprising: making a comparison between said second authentication server URL and said third authentication server URL to relate said second authentication server URL in said login information to said service group if said second authentication server URL matches said third authentication server URL.

21. The entry auxiliary program according to claim 20,
wherein said comparing comprises: making a comparison between said first authentication server URL and said second authentication server URL,
wherein said relating comprises:
relating said login information to a first adequacy level as said adequacy level, if said first authentication server URL completely matches said second authentication server URL;
relating said login information to a second adequacy level as said adequacy level, if said first authentication server URL matches said second authentication server URL at a host level;
relating said login information to a third adequacy level as said adequacy level, if said first authentication server URL matches said second authentication server URL at a domain level; and
relating said login information to a fourth adequacy level as said adequacy level, if said first authentication server URL does not match said second authentication server URL.

22. The entry auxiliary program according to claim 21,
wherein said assisting comprises:
automatically inputting authentication information included in said login information into an entry field for authentication information on said web page, if said login information is related to said first adequacy level; and
displaying authentication name indicating authentication information included in said login information, if said login information is related to said second adequacy level or said third adequacy level,
wherein when said displayed authentication name is selected, said assisting further comprises: inputting authentication information indicated by said selected authentication name into an entry field for authentication information on said web page.

23. The entry auxiliary program according to claim 20,
wherein when said second authentication server URL matches said third authentication server URL, said second authentication server URL and said third authentication server URL related to said service group are set as an identical group authentication server URL,
wherein said comparing comprises: making a comparison between said first authentication server URL and said identical group authentication server URL,
wherein said relating comprises:
relating said login information to a first adequacy level as said adequacy level, if said first authentication server URL completely matches said identical group authentication server URL;
relating said login information to a second adequacy level as said adequacy level, if said first authentication server URL matches said identical group authentication server URL at a host level;
relating said login information to a third adequacy level as said adequacy level, if said first authentication server URL matches said identical group authentication server URL at a domain level; and
relating said login information to a fourth adequacy level as said adequacy level, if said first authentication server URL does not match said identical group authentication server URL.

24. The entry auxiliary program according to claim 23,
wherein said assisting comprises:
automatically inputting authentication information included in said login information into an entry field for authentication information on said web page, if said login information is related to said first adequacy level; and
displaying authentication name indicating authentication information included in said login information, if said login information is related to said second adequacy level or said third adequacy level,
wherein when said displayed authentication name is selected, said assisting further comprises: inputting authentication information indicated by said selected authentication name into an entry field for authentication information on said web page.
